(19) United States
(12) Patent Application Publication
(10) Pub. No.: US 2025/0247664 A1
(43) Pub. Date: Jul. 31, 2025

(54) AUDIO TIME LATENCY-BASED SPATIAL ORIENTATION METHOD, ELECTRONIC DEVICE AND COMPUTER READABLE STORAGE MEDIUM

(71) Applicant: AMBIT MICROSYSTEMS (SHANGHAI) LTD., Shanghai (CN)

(72) Inventor: PO-CHANG LIN, New Taipei (TW)

(21) Appl. No.: 18/427,259

(22) Filed: Jan. 30, 2024

(51) Int. Cl. H04S 7/00; G06F 3/16

(52) U.S. Cl. CPC H04S 7/303; G06F 3/165; G06F 3/167; H04S 2420/01

(57) ABSTRACT

An audio time latency-based spatial orientation method is disclosed. A VR device is paired and connected with a plurality of speakers. Multiple audio time latencies from the VR device to the speakers are calculated. Current positions of the speakers relative to the VR device are calculated based on the audio time latencies and a virtual boundary is defined. Threshold values of the speakers relative to the virtual boundary are defined. It is determined whether the VR device is close to or beyond the virtual boundary according to the threshold values. If the VR device is close to or beyond the virtual boundary, the VR device issues an alarm.

### FIELD

The disclosure relates to time latency, and more particularly to an audio time latency-based spatial orientation method.

### BACKGROUND

Data transmission technology in audio transmission is well developed. However, the audio applications have increased, and requirements of audio synchronization have correspondingly increased. Thus, accuracy of audio latency becomes more important.

In virtual reality (VR) applications, users cannot know their positions in the real space, which may cause collision with audio devices while moving.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a flowchart of an embodiment of an audio time latency-based spatial orientation method of the present disclosure;

FIG. 2 is a schematic diagram of an embodiment of an audio latency calibration system of the present disclosure;

FIG. 3 is a schematic diagram of a first embodiment of an application of the audio time latency-based spatial orientation of the present disclosure;

FIG. 4 is a schematic diagram of a second embodiment of an application of the audio time latency-based spatial orientation of the present disclosure;

FIG. 5 is a schematic diagram of a third embodiment of an application of the audio time latency-based spatial orientation of the present disclosure;

FIG. 6 is a block diagram of an embodiment of the hardware architecture of an electronic device using the method of the present disclosure; and

FIG. 7 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

An embodiment of an audio time latency-based spatial orientation method calculates transmission latency and a sound arrival time from a virtual reality (VR) device to wireless home speakers of different brands through sound paths. The transmission latency between a VR device with a microphone and wireless speakers of different brands and a sound path length from the VR device to a position of the current wireless speaker can be calculated, and an accurate special position of the VR device can be calculated using a triangulation method.

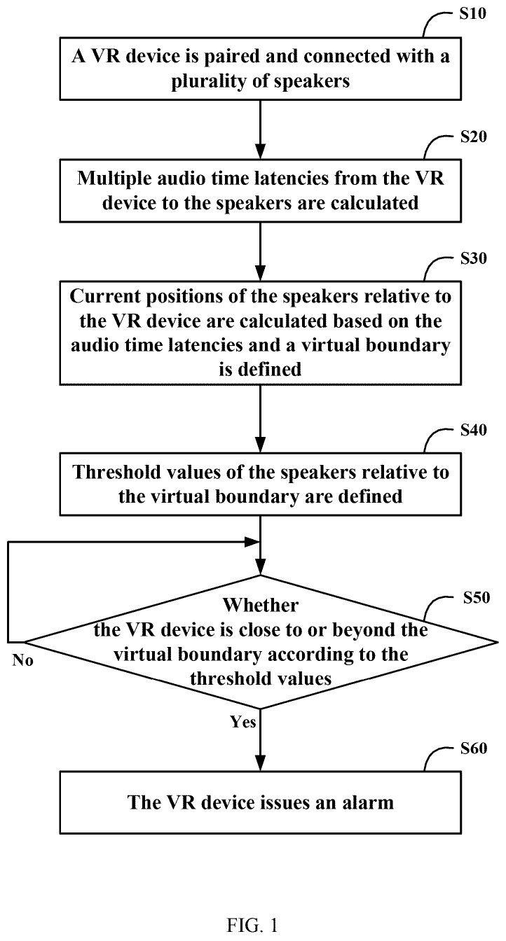

FIG. 1 is a flowchart of an embodiment of an audio time latency-based spatial orientation method of the present disclosure. According to different needs, the order of the steps in the flowchart can be changed, and some steps can be omitted.

In step S10, a VR device is paired with multiple speakers.

In step S20, multiple audio time latencies from the VR device to the speakers are calculated.

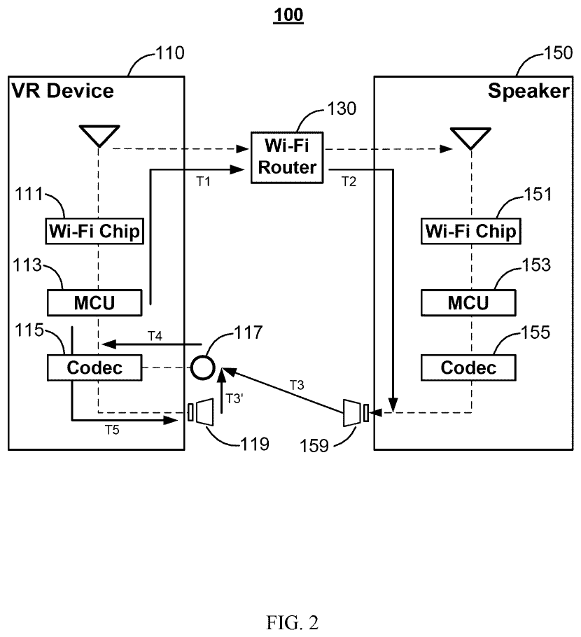

FIG. 2 is a schematic diagram of an embodiment of an audio latency calibration system of the present disclosure. The embodiment of the audio latency calibration system 100 comprises a virtual reality (VR) device 110, a Wi-Fi router 130 and a speaker 150. The VR device 110 and the speaker 150 may be speakers. The VR device 110 further comprises a Wi-Fi chip 111, a micro control unit (MCU) 113, a Coder-Decoder (Codec) 115, a microphone 117 and a trumpet 119. The speaker 150 further comprises a Wi-Fi chip 151, a MCU 153, a codec 155 and a trumpet 159.

T1 represents the time that MCU 111 transmits an audio signal to the Wi-Fi router 130. T2 represents the time that the audio signal is transmitted from the Wi-Fi router 130 to the speaker 150 and played by the trumpet 159. T3 represents the time that the audio signal is transmitted from the trumpet 159 to the microphone 117. T3′ represents the time that the audio signal is transmitted from the trumpet 119 to the microphone 117. T4 represents the time that the MCU 111 obtains the audio signal from the microphone 117. T5 represents the time the MCU 111 transmits the audio signal to the trumpet 119 via the codec 155.

The VR device 110 transmits the audio signal to the speaker 150 via the Wi-Fi router 130, thereby obtaining latency time period T1+T2. The speaker 150 transmits the audio signal to the microphone 117, thereby obtaining latency time period T3+T4. The VR device 110 transmits the audio signal to the speaker 150 and the trumpet 119 obtains the audio signal via the trumpet 159, thereby obtaining latency time period TL=T1+T2+T3+T4. The microphone 117 obtains the audio signal transmitted by the VR device 110, thereby obtaining latency time period of the VR device 110, TLᵢₙₜ=T3′+T4+T5 where T5 is known.

When the VR device 110 and the speaker 150 are located at a separation distance from each other, T3≅T3′ is obtained and TL−TLᵢₙₜ=(T1+T2+T3+T4)−(T3′+T4+T5)=T1+T2+T5+T3-T3′−T5. Therefore, T3-T3′=TL−TLᵢₙₜ−(T1+T2)−T5, where T3′ is extremely small and can be ignored. Therefore, the audio time latency T3 between the VR device 110 and the speaker 150 can be obtained.

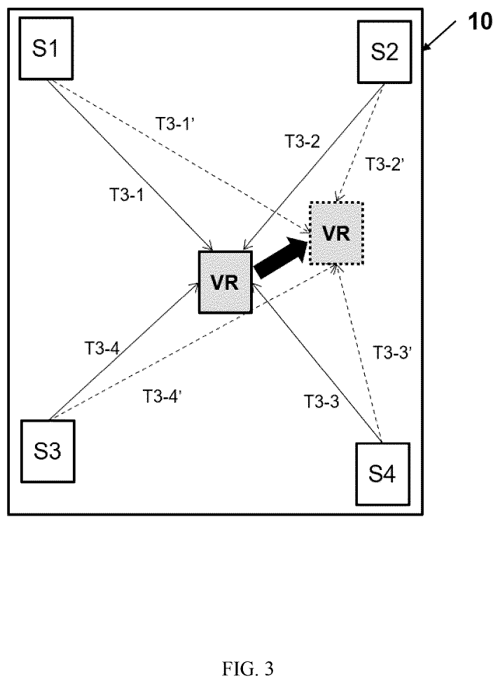

FIG. 3 is a schematic diagram of a first embodiment of an application of the audio time latency-based spatial orientation of the present disclosure, comprising a VR device and four speakers, for example, S1, S2, S3 and S4, while the four speakers form a spatial region, for example, a spatial region 10. Through the above operations, the audio time latencies T3-1, T3-2, T3-3 and T3-4 between the VR device (VR) and the speakers S1, S2, S3 and S4 can be obtained.

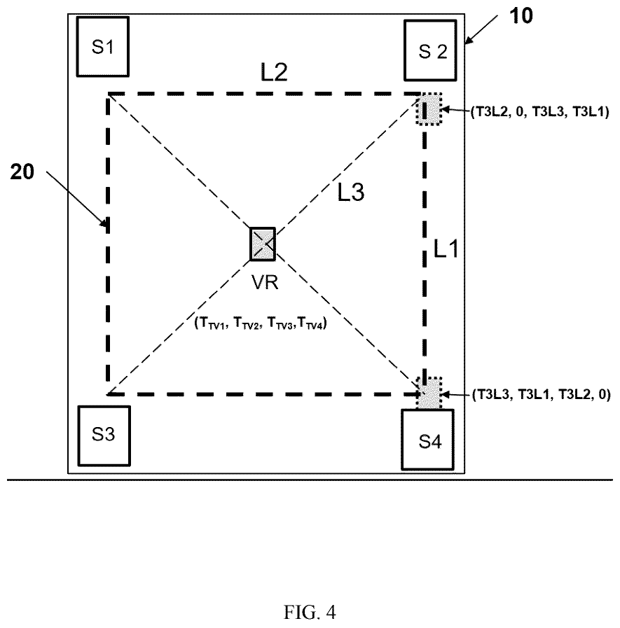

In step S30, referring to FIG. 4, current positions of the speakers S1, S2, S3 and S4 relative to the VR device are calculated based on the audio time latencies T3-1, T3-2, T3-3 and T3-4 and a virtual boundary 20 is defined. In addition, when the VR device moves, new audio time latencies T3-1′, T3-2′, T3-3′ and T3-4′ can be calculated, as shown in FIG. 3.

Referring to FIG. 4, the embodiment of an audio time latency-based spatial orientation method calculates position changes in VR space via the audio time latency T3. A set of observation values, for example, T_{OV1}, T_{OV2}, T_{OV3}, T_{OV4}, respectively correspond to the audio time latencies T3-1, T3-2, T3-3 and T3-4 and represent moving distance of the VR device relative to the speakers S1, S2, S3 and S4. For example, when the VR device moves from a center point of the virtual boundary 20 to the front of the speaker S2, the observation values (T3L2, 0, T3L3, T3L1) can be obtained. T_{OV1}=T3L2, which means that the VR device moves a L2 length to the speaker S2. T_{OV2}=0, which means that the distance between the VR device and speaker S2 is close to 0. T_{OV3}=T3L3, which means that the VR device moves a L3 length from the center point of the virtual boundary 20 to the speaker S2. T_{OV4}=T3L1, which means that the VR device moves a L1 length to reach the speaker S2.

In step S40, referring to FIG. 4, threshold values (TV) of the speakers S1, S2, S3 and S4 relative to the virtual boundary 20 are defined, including T_{TV1}, T_{TV2}, T_{TV3} and T_{TV4}.

In step S50, it is determined whether the VR device is close to or beyond the virtual boundary 20 according to the threshold values T_{TV1}, T_{TV2}, T_{TV3} and T_{TV4}.

In step S60, if the VR device is close to or beyond the virtual boundary 20, the VR device issues an alarm to let a VR user know that his current location is close to or beyond the virtual boundary 20, thereby improving the safety of the VR user.

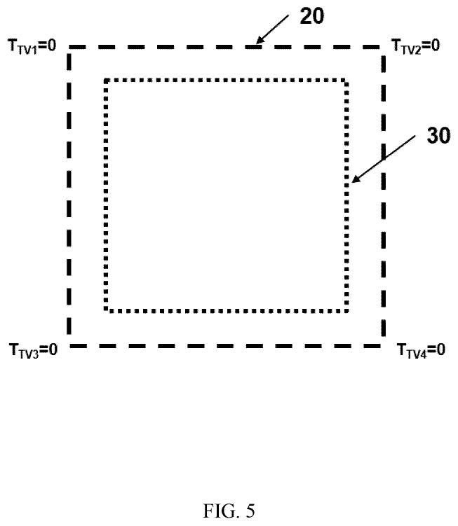

In addition, referring to FIG. 5, the range of the virtual boundary can be reduced by setting the threshold values T_{TV1}, T_{TV2}, T_{TV3} and T_{TV4}, for example, from the virtual boundary 20 to the virtual boundary 30.

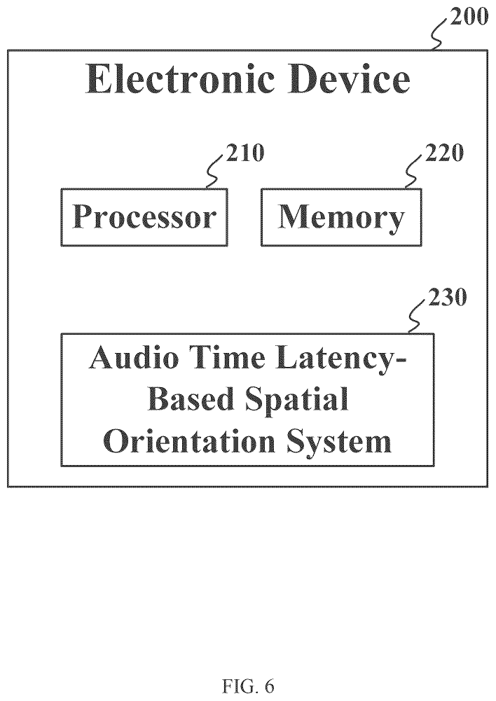

FIG. 6 is a block diagram of an embodiment of the hardware architecture of an electronic device using the audio time latency-based spatial orientation method of the present disclosure. The electronic device 200 may be, but is not limited to, connected to a processor 210, a memory 220, and an audio time latency-based spatial orientation system 230 via system buses. The electronic device 200 shown in FIG. 6 may include more or fewer components than those illustrated or may combine certain components.

The memory 220 stores a computer program, such as the audio time latency-based spatial orientation system 230, which is executable by the processor 210. When the processor 210 executes the audio time latency-based spatial orientation system 230, the blocks in one embodiment of the booting mode configuration method applied in the electronic device 200 are implemented, such as blocks S10 to S60 shown in FIG. 1.

It will be understood by those skilled in the art that FIG. 6 is merely an example of the electronic device 200 and does not constitute a limitation to the electronic device 200. The electronic device 200 may include more or fewer components than those illustrated or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the audio time latency-based spatial orientation system 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The audio time latency-based spatial orientation system 230 can be partitioned into one or more modules/units that are stored in the memory 220 and executed by the processor 210. The one or more modules/units may be a series of computer program instructions capable of performing particular functions of the audio time latency-based spatial orientation system 230.

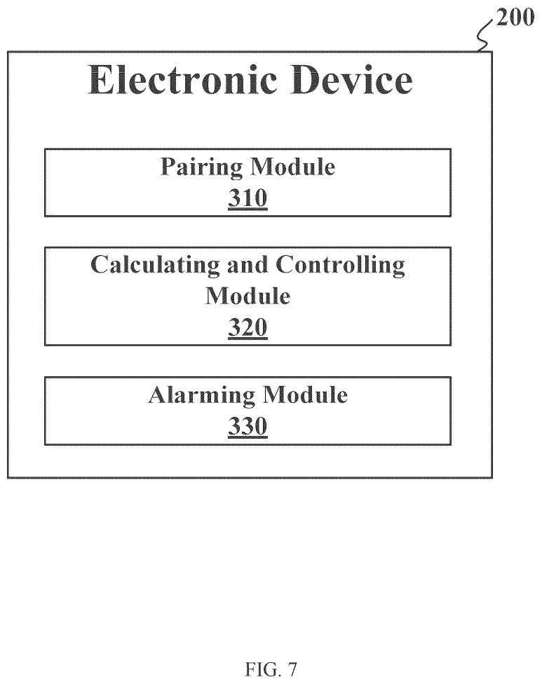

FIG. 7 is a schematic diagram of an embodiment of functional blocks of the electronic device using the method of the present disclosure.

The electronic device 200, for example, a VR device, comprises a pairing module 310, a calculating and controlling module 320 and an alarming module 330.

The pairing module 310 pairs and connects the VR device with a plurality of speakers, for example, S1, S2, S3, and S4.

The calculating and controlling module 320 calculates multiple audio time latencies from the VR device to the speakers, for example, S1, S2, S3, and S4, as shown in FIG. 3.

The calculating and controlling module 320 calculates current positions of the speakers S1, S2, S3 and S4 relative to the VR device based on the audio time latencies T3-1, T3-2, T3-3 and T3-4 and defines a virtual boundary 20. In addition, when the VR device moves, the calculating and controlling module 320 calculates new audio time latencies T3-1′, T3-2′, T3-3′ and T3-4′, as shown in FIG. 3.

The calculating and controlling module 320 defines threshold values (TV) of the speakers S1, S2, S3 and S4 relative to the virtual boundary 20, including T_{TV1}, T_{TV2}, T_{TV3} and T_{TV4} as shown in FIG. 4.

The calculating and controlling module 320 determines whether the VR device is close to or beyond the virtual boundary 20 according to the threshold values T_{TV1}, T_{TV2}, T_{TV3} and T_{TV4}.

If the VR device is close to or beyond the virtual boundary 20, the alarming module 330 issues an alarm to let a VR user know that his current location is close to or beyond the virtual boundary 20, thereby improving the safety of the VR user.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An audio time latency-based spatial orientation method executable by an electronic device, the audio time latency-based spatial orientation method comprising:
pairing and connecting a virtual reality (VR) device with a plurality of speakers;
calculating multiple audio time latencies from the VR device to the speakers;
calculating current positions of the speakers relative to the VR device based on the audio time latencies and defining a virtual boundary;
defining threshold values of the speakers relative to the virtual boundary;
determining whether the VR device is close to or beyond the virtual boundary according to the threshold values; and
if the VR device is close to or beyond the virtual boundary, enabling the VR device to issue an alarm.

2. The audio time latency-based spatial orientation method of claim 1, further comprising:
changing settings of the threshold values to adjust the range size of the virtual boundary.

3. An electronic device, which includes a memory, a processor, and a serial number length adjustment program stored in the memory and operable on the processor, wherein the serial number length adjustment program is executed by the processor to implement following steps:
pairing and connecting a virtual reality (VR) device with a plurality of speakers;
calculating multiple audio time latencies from the VR device to the speakers;
calculating current positions of the speakers relative to the VR device based on the audio time latencies and defining a virtual boundary;
defining threshold values of the speakers relative to the virtual boundary;
determining whether the VR device is close to or beyond the virtual boundary according to the threshold values; and
if the VR device is close to or beyond the virtual boundary, enabling the VR device to issue an alarm.

4. The device of claim 3, wherein the serial number length adjustment program is executed by the processor to implement following step:
changing settings of the threshold values to adjust the range size of the virtual boundary.

5. A non-transitory computer-readable storage medium storing game program which causes a computer to execute:
a process of pairing and connecting a virtual reality (VR) device with a plurality of speakers;
a process of calculating multiple audio time latencies from the VR device to the speakers;
a process of calculating current positions of the speakers relative to the VR device based on the audio time latencies and defining a virtual boundary;
a process of defining threshold values of the speakers relative to the virtual boundary;
a process of determining whether the VR device is close to or beyond the virtual boundary according to the threshold values; and
a process of, if the VR device is close to or beyond the virtual boundary, enabling the VR device to issue an alarm.

6. The non-transitory computer-readable storage medium of claim 5, wherein the game program causes the computer to further execute:
changing settings of the threshold values to adjust the range size of the virtual boundary.
